(19) United States
(12) Patent Application Publication
(10) Pub. No.: US 2025/0373415 A1
(43) Pub. Date: Dec. 4, 2025

(54) NETWORK SYSTEM, INFORMATION PROCESSING DEVICE, AND COMMUNICATION METHOD

(71) Applicants: Kristopher Andrew TATE, Kyoto-shi, Kyoto (JP); connectFree Corporation, Kyoto-shi, Kyoto (JP)

(72) Inventor: Kristopher Andrew TATE, Kyoto-shi, Kyoto (JP)

(73) Assignees: Kristopher Andrew TATE, Kyoto-shi, Kyoto (JP); connectFree Corporation, Kyoto-shi, Kyoto (JP)

(21) Appl. No.: 18/876,164

(22) PCT Filed: Sep. 11, 2023
(86) PCT No.: PCT/JP2023/032977

§ 371 Date: Dec. 17, 2024

(30) Foreign Application Priority Data
Sep. 12, 2022 (JP) 2022-144399

(51) Int. Cl. H04L 9/08; H04L 9/14; H04L 9/32; H04L 61/50

(52) U.S. Cl. CPC H04L 9/0825; H04L 9/14; H04L 9/3268; H04L 61/50

(57) ABSTRACT

A network system includes a plurality of devices. Each of the plurality of devices includes: a communication unit for performing data communication with another device; and a determination unit that determines a network address of another device based on a public key received from another device. The first device has a first public key and a second public key, and is configured to be able to respond to both an access designating a first network address determined based on the first public key and an access designating a second network address determined based on the second public key.

### TECHNICAL FIELD

The present disclosure relates to a network system including a plurality of devices, an information processing device for the network system, and a communication method in the network system.

### BACKGROUND ART

The development of information and communication technology (ICT) has been remarkable in recent years, and devices connected to a network, such as the Internet, are not limited to information processing devices, such as conventional personal computers or smartphones, and are spreading to various things. Such a technology trend is called “IoT (Internet of Things)”, and various technologies and services have been proposed and put into practical use. In the future, a world is envisioned in which billions of people on Earth and tens or trillions of devices are connected at the same time. In order to realize such a networked world, it is necessary to provide a solution that is simpler, safer, and more freely connected.

As one core technology for providing such a solution, WO 2020/049754 (Patent Document 1) discloses a completely new method for determining network addresses using public keys.

### CITATION LIST

### Patent Document

Patent Document 1: WO 2020/049754

### SUMMARY OF THE INVENTION

### Problem to be Solved by the Invention

The present disclosure provides a solution to a novel problem that may arise in a network system that determines network addresses using public keys.

### Means for Solving Problem

According to one aspect of the present disclosure, there is provided a network system including a plurality of devices. Each of the plurality of devices includes: a communication unit for performing data communication with another device; and a determination unit that determines a network address of the another device based on a public key received from the another device. A first device included in the plurality of devices has a first public key and a second public key, and is configured to be able to respond to both an access designating a first network address determined based on the first public key and an access designating a second network address determined based on the second public key.

The first device may be configured to notify of at least one of having a plurality of network addresses and having a plurality of public keys.

When the access designating the first network address is received, the first device may notify a source of the access of at least one of existence of the second public key and existence of the second network address.

The first device may have a first digital certificate associated with the first public key. When validity of the first digital certificate is about to expire or has expired, the first device may notify the access source of at least one of the existence of the second public key and the existence of the second network address.

When an inquiry about validity of the first network address is received from another device, the first device may respond according to a validity of the first digital certificate.

When the second public key is acquired from the first device, a second device included in the plurality of devices may determine a second network address based on the second public key and update a routing table with the determined second network address.

The second device may notify an application running on the second device of the second network address.

The first device may transmit a third public key owned by a third device to the second device.

An information processing device capable of performing data communication with another information processing device according to another aspect of the present disclosure includes a determination unit that determines a network address of the another device based on a public key received from the another device. The information processing device has a first public key and a second public key, and is configured to be able to respond to both an access designating a first network address determined based on the first public key and an access designating a second network address determined based on the second public key.

A communication method in a network system including a plurality of devices according to still another aspect of the present disclosure includes: a step in which each of the plurality of devices stores its own public key; a step in which each of the plurality of devices determines a network address of another device based on a public key received from the another device; and a step of responding to both an access designating a first network address determined based on a first public key and an access designating a second network address determined based on a second public key when a first device included in the plurality of devices has the first public key and the second public key.

### Effect of the Invention

According to the present disclosure, it is possible to provide a solution to the new problem that may arise in a network system that determines network addresses using public keys.

### BRIEF DESCRIPTION OF DRAWINGS

FIG. 1 is a schematic diagram showing an example of communication processing in a network system according to the present embodiment;

FIG. 2 is a schematic diagram showing another example of communication processing in the network system according to the present embodiment;

FIG. 3 is a schematic diagram showing an example of processing for generating a public key and a digital certificate in the network system according to the present embodiment;

FIG. 4 is a flowchart showing an example of a public key generation process in the network system according to the present embodiment;

FIG. 5 is a flowchart showing an example of a digital certificate generation process in the network system according to the present embodiment;

FIG. 6 is a schematic diagram showing an example of the hardware configuration of a device according to the present embodiment;

FIG. 7 is a schematic diagram showing an example of the functional configuration of the device according to the present embodiment;

FIG. 8 is a schematic diagram showing an example of processing when a device has a plurality of network addresses in the network system according to the present embodiment;

FIG. 9 is a schematic diagram showing an example of processing for notifying of a plurality of network addresses in the network system according to the present embodiment;

FIG. 10 is a diagram for explaining a history of network addresses in the network system according to the present embodiment;

FIG. 11 is a schematic diagram showing an example of processing when a network address is changed in the network system according to the present embodiment;

FIG. 12 is a schematic diagram showing another example of processing when a network address is changed in the network system according to the present embodiment;

FIG. 13 is a schematic diagram showing an example of updating a routing table in the network system according to the present embodiment; and

FIG. 14 is a schematic diagram showing an example of processing for notifying of a network address of another device in the network system according to the present embodiment.

### MODE(S) FOR CARRYING OUT THE INVENTION

An embodiment according to the present disclosure will be described in detail with reference to the diagrams. In addition, the same or corresponding portions in the diagrams are denoted by the same reference numerals, and the description thereof will not be repeated.

<a. Communication Processing in Network System 1>

First, an example of communication processing in a network system 1 according to the present embodiment will be described.

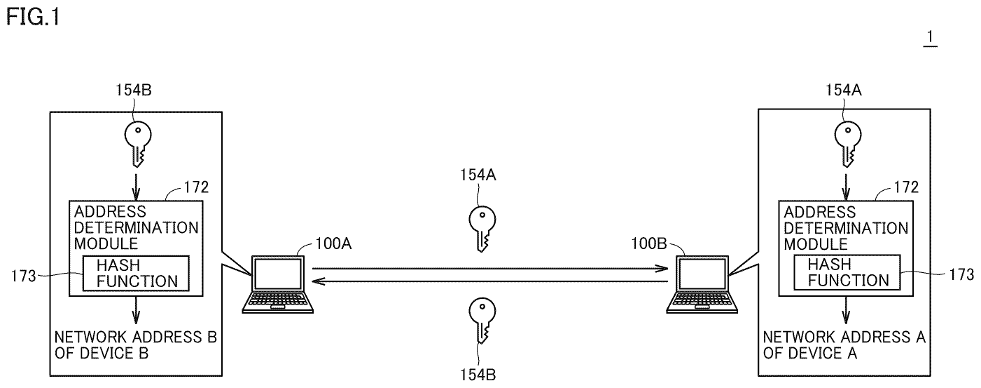

FIG. 1 is a schematic diagram showing an example of communication processing in the network system 1 according to the present embodiment. Referring to FIG. 1, the network system 1 includes a plurality of devices 100A, 100B, . . . (hereinafter, also collectively referred to as “devices 100”).

In this specification, the term “device” includes any information processing device capable of performing communication processing. Examples of the devices include (fixed and portable) personal computers, smartphones, tablets, smartphones, wearable devices (for example, smart watches or AR glasses) worn on the user's body (for example, an arm or a head), smart home appliances, connected automobiles, control equipment installed in factories and the like, and IoT devices.

Each of the devices 100 has a public key 154. Each of the devices 100 may have a private key corresponding to the public key 154.

In the example shown in FIG. 1, the device 100A has a public key 154A and the device 100B has a public key 154B.

When the device 100A and the device 100B start communication, the device 100A transmits the public key 154A that the device 100A has to the device 100B. Similarly, the device 100B transmits the public key 154B that the device 100B has to the device 100A.

The device 100A inputs the public key 154B to an address determination module 172 to determine a network address B of the device 100B. Similarly, the device 100B inputs the public key 154A to the address determination module 172 to determine a network address A of the device 100A.

Through the above process, the device 100A and the device 100B can acquire each other's network addresses.

In addition, the exchange of the public key 154 between the device 100A and the device 100B does not need to be performed every time communication is started, but needs to be performed at least once.

In this specification, “network address” refers to identification information for identifying a device present on a network, and is not limited to commonly used IP (Internet Protocol) addresses (IPV4 and IPV6), but may also be a unique address system (any address length can be adopted).

The address determination module 172 of the device 100 determines the network address of another device 100 based on the public key 154 received from another device 100. More specifically, the address determination module 172 calculates a hash value from the input public key 154 using an irreversible cryptographic hash function (hereinafter, also referred to as a “hash function 173”). The address determination module 172 determines a network address using the calculated hash value.

For example, the network address may be determined from the hash value alone. In this case, the network address may be designed to calculate a hash value having a length equal to or greater than the number of digits (or bits) required for the network address.

When determining an IP address for IPV6, a 128-bit hash value may be calculated, and when determining an IP address for IPV4, a 32-bit hash value may be calculated. In addition, when calculating a 128-bit hash value, any 32-bit portion of the calculated hash value may be extracted and determined as an IP address for IPV4. Alternatively, a 256-bit or 512-bit hash value may be calculated, and then any 128-bit (or 32-bit) portion of the calculated hash value may be extracted and determined as an IP address.

In addition, a value set in advance may be added to the calculated hash value to determine the network address. For example, the result of changing the value of a specific digit (or a specific bit position) of a hash value having a predetermined bit length to a value set in advance (for example, a value indicating a specific attribute) may be determined as the network address.

The hash function 173 may be any function that is common among the devices 100. For example, BLAKE or Keccak can be used. Additionally, any cryptographic hash function developed in the future can be adopted.

In addition, in addition to the public key 154, any character string may be additionally input to the hash function 173. As the any character string, for example, the name of an organization associated with the network address or a trademark owned by the organization may be used.

In addition, in order to increase the level of authentication for the network address, a digital certificate indicating the validity of the public key 154 may be used.

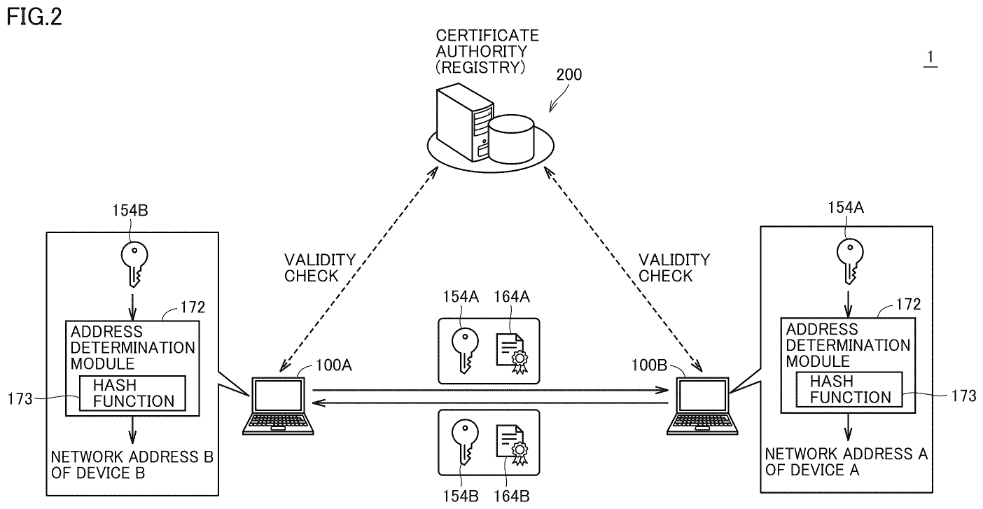

FIG. 2 is a schematic diagram showing another example of communication processing in the network system according to the present embodiment. Referring to FIG. 2, each of the devices 100 has the public key 154 and a digital certificate 164 associated with the public key 154.

The network system 1 may further include a certificate authority 200. The certificate authority 200 issues the digital certificate 164 associated with the public key 154 in response to a request. The network system 1 may include a plurality of certificate authorities 200. When a plurality of certificate authorities 200 are disposed, a root certificate authority and one or more intermediate certificate authorities.

In the example shown in FIG. 1, the device 100A has the public key 154A and a digital certificate 164A, and the device 100B has the public key 154B and a digital certificate 164B.

When the device 100A and the device 100B start communication, the device 100A transmits the public key 154A and the digital certificate 164A that the device 100A has to the device 100B. Similarly, the device 100B transmits the public key 154B and the digital certificate 164B that the device 100B has to the device 100A.

The device 100A determines the validity of the public key 154B using the digital certificate 164B from the device 100B. If the validity of the public key 154B can be confirmed, the device 100A inputs the public key 154B to the address determination module 172 to determine the network address B of the device 100B.

Similarly, the device 100B determines the validity of the public key 154B using the digital certificate 164A from the device 100A. If the validity of the public key 154B can be confirmed, the device 100B inputs the public key 154A to the address determination module 172 to determine the network address A of the device 100A.

Through the above process, the device 100A and the device 100B can acquire each other's network addresses. The acquired network address is more reliably authenticated without being tampered with due to the above-described mechanism including the digital certificate 164. By using the authenticated network address, the validity of the network address of the device 100 can be guaranteed to the communication partner or a third party.

The device 100A and the device 100B may inquire of the certificate authority 200 to determine the validity of the digital certificate 164B and the digital certificate 164A.

In the following explanation, an example of exchanging the public key 154 and the digital certificate 164 associated with the public key 154 between the devices 100 will mainly be described. However, the digital certificate 164 and the certificate authority 200 are not essential components, and may be adopted as appropriate according to the level of authentication required or the operation.

### <B. Processing for Generating a Public Key and a Digital Certificate in the Network System 1>

Next, an example of processing for generating a public key and a digital certificate in the network system 1 according to the present embodiment will be described.

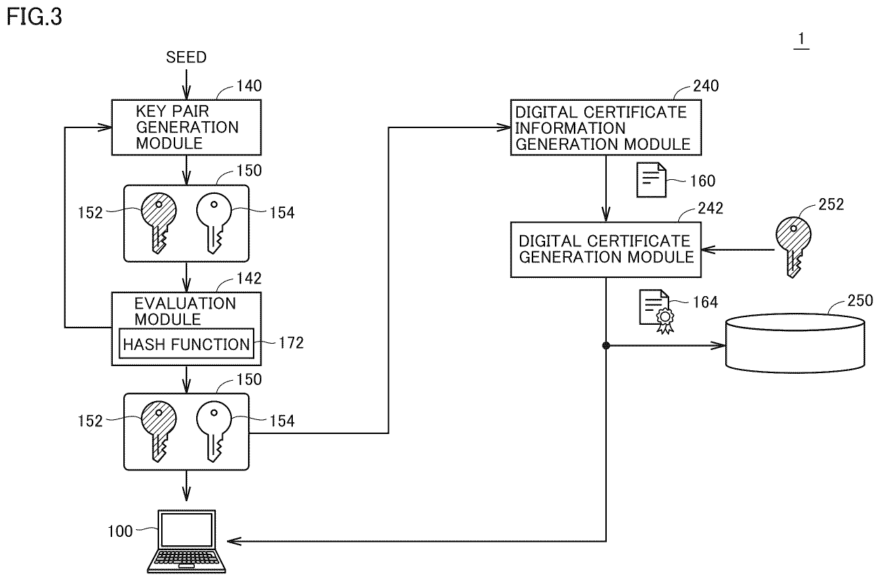

FIG. 3 is a schematic diagram showing an example of processing for generating a public key and a digital certificate in the network system 1 according to the present embodiment. Referring to FIG. 3, the network system 1 includes a key pair generation module 140, an evaluation module 142, a digital certificate information generation module 240, and a digital certificate generation module 242.

The key pair generation module 140 sequentially generates a key pair 150 including a private key 152 and a public key 154. As an example, the key pair generation module 140 generates a bit string of a predetermined length (for example, 512 bits) as the private key 152 using a random number generator. Then, the key pair generation module 140 generates the public key 154 including a bit string of a predetermined length (for example, 256 bits) from the private key 152 according to a known asymmetric encryption algorithm (for example, an elliptic curve encryption algorithm).

The random number generator used in the key pair generation module 140 may be realized by using a function provided by the OS (Operating System), or may be realized by using a hard-wired circuit such as an ASIC (Application Specific Integrated Circuit).

When the device 100 acquires the key pair 150 from the outside, the key pair 150 (the private key 152 and the public key 154) may be acquired, or only the private key 152 may be acquired and the public key 154 may be generated by the device 100 itself.

The evaluation module 142 determines whether or not the public key 154 included in the generated key pair 150 can be used as a network address. More specifically, the evaluation module 142 has the hash function 173, and calculates a hash value from the public key 154 using the hash function 173 and determines whether or not the calculated hash value is appropriate as a network address. The determination regarding whether or not the calculated hash value is appropriate as a network address may be performed based on whether or not a specific digit (or bit position) of the calculated hash value indicates a predefined value. More specifically, it may be determined whether or not the calculated hash value conforms to predetermined network address allocation rules. For example, when the first two digits of the calculated hash value (16 bits in the case of 8-bit representation) indicate “00”, determination as an appropriate network address may be made.

The public key 154 included in the key pair 150 determined to be able to be used as a network address by the evaluation module 142 is output to the digital certificate information generation module 240.

The digital certificate information generation module 240 generates digital certificate information 160 included in the digital certificate 164 associated with the public key 154. The digital certificate information 160 includes, for example, the following information.
Name of issuer
Name of subject
Subject public key
Validity

In the network system 1 according to the present embodiment, the name of the certificate authority 200 is stored as the name of the issuer, the name of the device 100 is stored as the name of the subject, and the value of the public key 154 output from the evaluation module 142 is stored as the subject public key.

As the validity, a start date and time and an end date and time may be stored. The length of the validity can be set arbitrarily, but may be set to a period that is considered to ensure cryptographic security, for example.

The digital certificate generation module 242 generates the digital certificate 164 by adding the issuer's signature 162 (signature value) to the digital certificate information 160. More specifically, the digital certificate generation module 242 calculates a hash value of the digital certificate information 160 as the signature 162 using a private key 252 of the certificate authority 200.

The digital certificate generation module 242 may include information, which indicates the signature algorithm used to calculate the signature 162, in the digital certificate 164.

The digital certificate generation module 242 may include the subject public key in the digital certificate 164. Since the digital certificate 164 includes the public key of the issuer, the validity of the digital certificate 164 can be sequentially confirmed along the certificate chain from the intermediate certificate authority to the root certificate authority.

The digital certificate generation module 242 registers the generated digital certificate 164 in a registry 250, and outputs the generated digital certificate 164 to the device 100.

In addition, the key pair generation module 140 and the evaluation module 142 may be disposed in the device 100, or may be disposed in the certificate authority 200. The digital certificate information generation module 240 and the digital certificate generation module 242 are disposed in the certificate authority 200. In addition, the registry 250 may be disposed in the certificate authority 200 separate from the certificate authority 200 that generates the digital certificate 164.

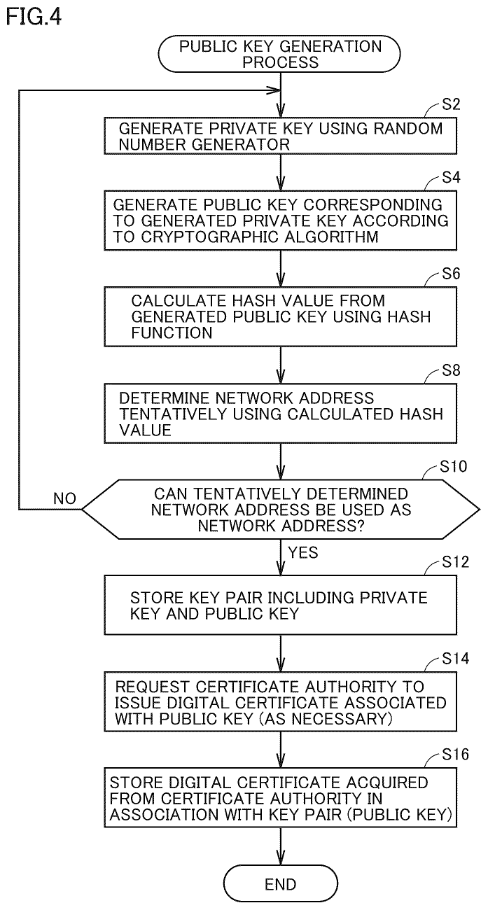

FIG. 4 is a flowchart showing an example of a process for generating the public key 154 in the network system 1 according to the present embodiment. FIG. 4 shows, as an example, how the device 100 generates the public key 154 for use as a network address. However, the entirety or a part of the process of generating the public key 154 may be performed by a processing entity other than the device 100.

Referring to FIG. 4, the device 100 generates the private key 152 using a random number generator (step S2). The device 100 may acquire the private key 152 from the outside. Then, the device 100 generates the public key 154 corresponding to the generated private key 152 according to a cryptographic algorithm (step S4).

The device 100 calculates a hash value from the generated public key 154 using the hash function 173 (step S6), and tentatively determines a network address using the calculated hash value (step S8).

Then, the device 100 determines whether or not the tentatively determined network address can be used as a network address (step S10). If the tentatively determined network address cannot be used (NO in step S10), the process from step S2 is repeated.

If the tentatively determined network address can be used (YES in step S10), the device 100 stores the key pair 150 including the private key 152 and the public key 154 (step S12).

If necessary, the device 100 requests the certificate authority 200 to issue the digital certificate 164 associated with the public key 154 (step S14). When the digital certificate 164 is acquired from the certificate authority 200, the device 100 stores the digital certificate 164 in association with the key pair 150 (public key 154) (step S16). Then, the process ends.

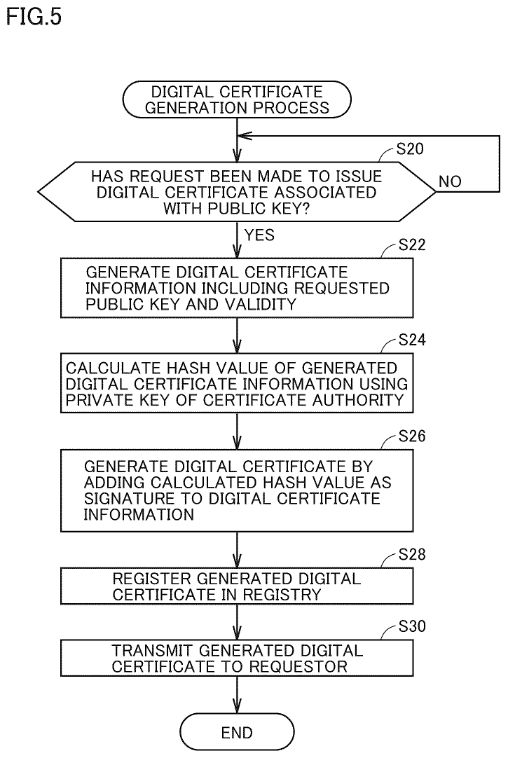

FIG. 5 is a flowchart showing an example of a process for generating a digital certificate in network system 1 according to the present embodiment. FIG. 5 shows an example in which the certificate authority 200 generates the digital certificate 164.

Referring to FIG. 5, if a request is made to issue the digital certificate 164 associated with the public key 154 (YES in step S20), the certificate authority 200 generates the digital certificate information 160 including the requested public key 154 and validity (step S22), and calculates a hash value of the generated digital certificate information 160 using the private key 252 of the certificate authority 200 (step S24). The certificate authority 200 generates the digital certificate 164 by adding the calculated hash value as the signature 162 to the digital certificate information 160 (step S26).

Then, the certificate authority 200 registers the generated digital certificate 164 in the registry 250 (step S28), and transmits the generated digital certificate 164 to the requestor (step S30). Then, the process ends.

### <C. Example of Configuration of Device 100>

An example of the hardware configuration of the device 100 according to the present embodiment will be described.

### (c1: Hardware Configuration Example)

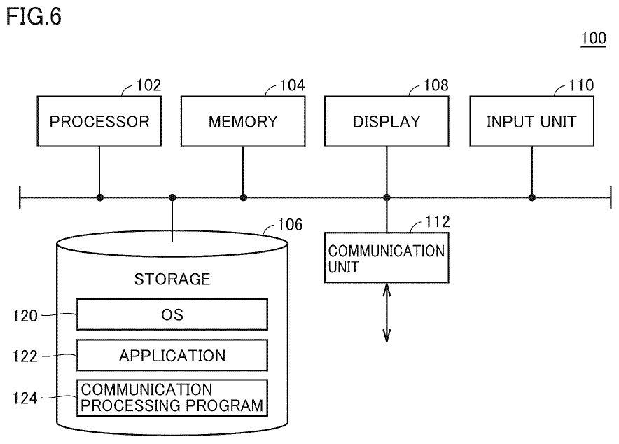

FIG. 6 is a schematic diagram showing an example of the hardware configuration of the device 100 according to the present embodiment. FIG. 6 shows an example of the hardware configuration of the device 100, which is a personal computer, as a typical example.

Referring to FIG. 6, the device 100 includes one or more processors 102, a memory 104, a storage 106, a display 108, an input unit 110, and a communication unit 112.

The processor 102 is an arithmetic circuit that sequentially reads and executes computer-readable instructions. The processor 102 is, for example, a CPU (Central Processing Unit), an MPU (Micro Processing Unit), or a GPU (Graphics Processing Unit). The device 100 may have a plurality of processors 102, or a single processor 102 may have a plurality of cores.

The processor 102 may include not only a processor in the narrow sense but also a hard-wired circuit, such as an ASIC (Application Specific Integrated Circuit) in which circuits for implementing processing are formed in advance and an FPGA (Field-Programmable Gate Array) in which a configuration for implementing processing is realized through configuration. In addition, in this specification, the processor 102 may also include a System on Chip (SoC) in which various processing elements are integrated. Therefore, the processor 102 can also be referred to as a processing circuitry.

The memory 104 is, for example, a volatile storage device, such as a DRAM (Dynamic Random Access Memory) or an SRAM (Static Random Access Memory). The storage 106 is, for example, a non-volatile storage device such as an HDD (Hard Disk Drive), an SSD (Solid State Drive), or a flash memory.

The storage 106 stores various programs and various kinds of data. The processor 102 implements various processes described below by loading designated programs, among the various programs stored in the storage 106, to the memory 104 and executing the programs in a sequential manner.

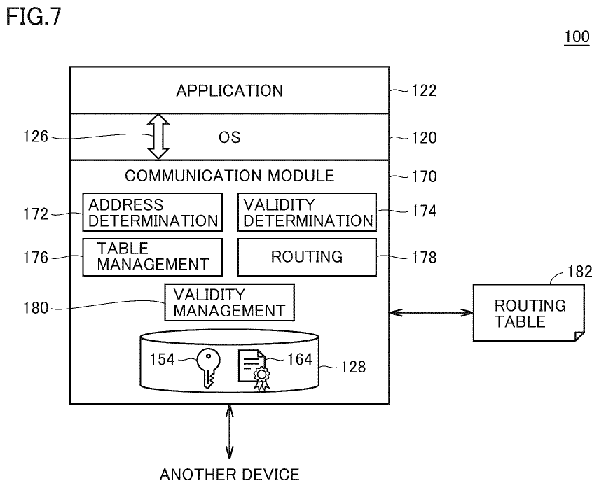

As an example, the storage 106 stores an OS 120, one or more applications 122, and a communication processing program 124. The OS 120 is a program that provides an environment for the device 100 to perform various processes. The application 122 is a program that is created arbitrarily according to the purpose. The communication processing program 124 is a program for implementing the communication processing according to the present embodiment. In addition, the storage 106 may have a data storage area 128 (see FIG. 7) that is prepared to store the public key 154 and the digital certificate 164.

The data storage area 128 may be realized by using a security chip (not shown) instead of the storage 106.

Thus, the device 100 has a storage unit (for example, the storage 106 or a security chip) for storing its own public key 154 and digital certificate 164 associated with the public key 154. In addition, the public key 154 of the device 100 may be calculated each time from the private key 152 stored in the storage unit. That is, the public key 154 of the device 100 does not need to be stored permanently in a storage unit, and may be generated whenever requested.

The display 108 presents the processing results of the processor 102 and the like to the outside. The display 108 may be, for example, an LCD (Liquid Crystal Display) or an organic EL (Electro-Luminescence) display. The display 108 may be a head-mounted display worn on the user's head, or may be a projector that projects an image onto the screen. The display 108 may be an indicator disposed anywhere on the housing of the device 100.

The input unit 110 receives a user operation on the device 100 and the like. The input unit 110 may be, for example, a keyboard, a mouse, a touch panel disposed on the display 108, or a switch disposed anywhere on the housing of the device 100.

The communication unit 112 performs data communication with another device 100. More specifically, the communication unit 112 is a network interface for connecting the device 100 to the network. Examples of the communication unit 112 include wired connection terminals, such as serial ports including an Ethernet (registered trademark) port, a USB (Universal Serial Bus) port, and an IEEE1394 and a legacy parallel port. Alternatively, the communication unit 112 may include processing circuitries and antennas for wireless communication with devices, routers, mobile base stations, and the like. The wireless communication supported by the communication unit 112 may be any of Wi-Fi (registered trademark), Bluetooth (registered trademark), ZigBee (registered trademark), LPWA (Low Power Wide Area), GSM (registered trademark), W-CDMA, CDMA200, LTE (Long Term Evolution), and 5th generation mobile communication system (5G), for example.

The device 100 may further include a component for reading various programs and/or various kinds of data from non-transitory media in which various programs (computer-readable instructions) and/or various kinds of data are stored. The media may be, for example, an optical medium such as a DVD (Digital Versatile Disc) or a semiconductor medium such as a USB memory.

In addition, instead of installing various programs and/or various kinds of data on the device 100 through the media, necessary programs and data may be installed on the device 100 from a distribution server on the network.

In addition, the configuration for providing the functions and executing the processes according to the present embodiment is not limited to the example of the hardware configuration of the device 100 shown in FIG. 6, and any hardware configuration according to the time of the implementation may be adopted.

### (c2: Functional Configuration Example)

FIG. 7 is a schematic diagram showing an example of the functional configuration of the device 100 according to the present embodiment. Referring to FIG. 7, the device 100 includes the OS 120, an application 122 for transmitting and receiving data to and from another device 100, and a communication module 170. The communication module 170 may be realized by the processor 102 executing the communication processing program 124 (FIG. 6), or may be realized by a dedicated hard-wired circuit.

The application 122 transmits and receives data to and from another device 100 (or an application running on another device 100) through the communication module 170. The communication module 170 has an interface 126 for receiving a command from the application 122.

The communication module 170 performs communication processing according to the present embodiment. The communication module 170 includes the address determination module 172, a validity determination module 174, a table management module 176, a routing module 178, and a validity management module 180.

The communications module 170 stores the public key 154 and the digital certificate 164 associated with the public key 154 in the data storage area 128. In addition, the communication module 170 can refer to a routing table 182.

The address determination module 172 determines the network address of another device 100 from the public key 154 of another device 100 as described above.

The validity determination module 174 determines the validity of the public key 154B using the digital certificate 164 from another device 100.

The table management module 176 adds and modifies the information stored in the routing table 182.

The routing module 178 transmits data (for example, packets or frames) to the destination device 100 with reference to the routing table 182. The routing module 178 can not only transmit data that the device itself is to transmit but also transmit data received from another device 100.

The validity management module 180 manages whether or not the validity of the digital certificate 164 is sufficient, and performs processing described below when the validity of the digital certificate 164 is about to expire or has expired.

The routing table 182 stores the network address of the device 100 in association with routing information. The routing module 178 determines a path, along which data is to be transmitted to the destination device 100, with reference to the routing table 182.

The routing table 182 may be disposed in the device 100, or may be disposed in a server device separate from the device 100.

In addition, the communication module 170 may include the key pair generation module 140 and the evaluation module 142 shown in FIG. 3.

### <D. Plurality of Network Addresses>

Next, an example in which the device 100 has a plurality of public keys 154 (or a plurality of network addresses calculated respectively from the plurality of public keys 154) will be described.

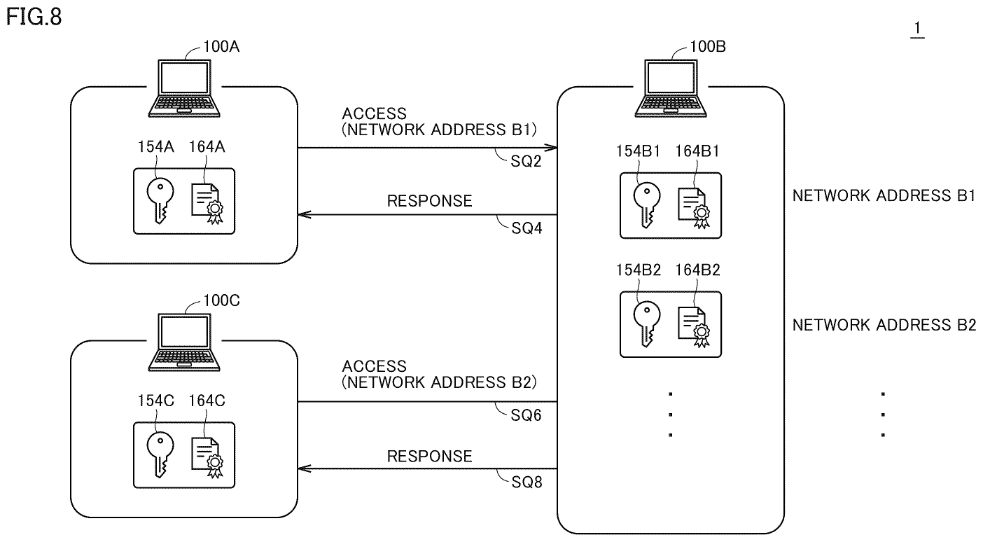

FIG. 8 is a schematic diagram showing an example of processing when the device 100 has a plurality of network addresses in the network system 1 according to the present embodiment.

Referring to FIG. 8, it is assumed that the device 100B has a public key 154B1 and a digital certificate 164B1 associated with the public key 154B1 and a public key 154B2 and a digital certificate 164B2 associated with the public key 154B2. The device 100B may have three or more pairs of public keys 154 and digital certificates 164.

Here, the public key 154B1 corresponds to a network address B1, and the public key 154B2 corresponds to a network address B2.

The device 100B is configured to be able to respond to both an access designating the network address B1 and an access designating the network address B2. That is, the device 100B has a plurality of network addresses.

For example, it is assumed that the device 100A accesses the device 100B by designating the network address B1 (sequence SQ2). Then, the device 100B responds to the device 100A (sequence SQ4). Similarly, it is assumed that the device 100C accesses the device 100B by designating the network address B2 (sequence SQ6). Then, the device 100B responds to the device 100C (sequence SQ8).

In addition, although FIG. 8 illustrates communication processing between the device 100A and the device 100B and communication processing between the device 100C and the device 100B, the same applies to communication processing between any devices 100.

Thus, in the network system 1 according to the present embodiment, the device 100 can have a plurality of network addresses.

For example, when one device 100 belongs to a plurality of domains, the device 100 can communicate with another device 100 belonging to any of the domains by having a network address corresponding to each domain. That is, the device 100 can act as a member of each domain.

In addition, when a plurality of hash functions 173 are available, the device 100 may have respective network addresses determined by processing the same public key 154 with each of the hash functions 173.

As shown in FIG. 8, when the device 100 has a plurality of network addresses (or a plurality of public keys 154), the device 100 may notify any device 100 that the device 100 has a plurality of network addresses and/or a plurality of public keys 154. More specifically, the following communication processing may be performed.

For example, when the device 100B having a plurality of network addresses receives an access designating one network address (network address B1), the device 100B may notify the device 100A, which is the source of the access, that the device 100A has a plurality of network addresses (or that the device 100A has a plurality of public keys 154).

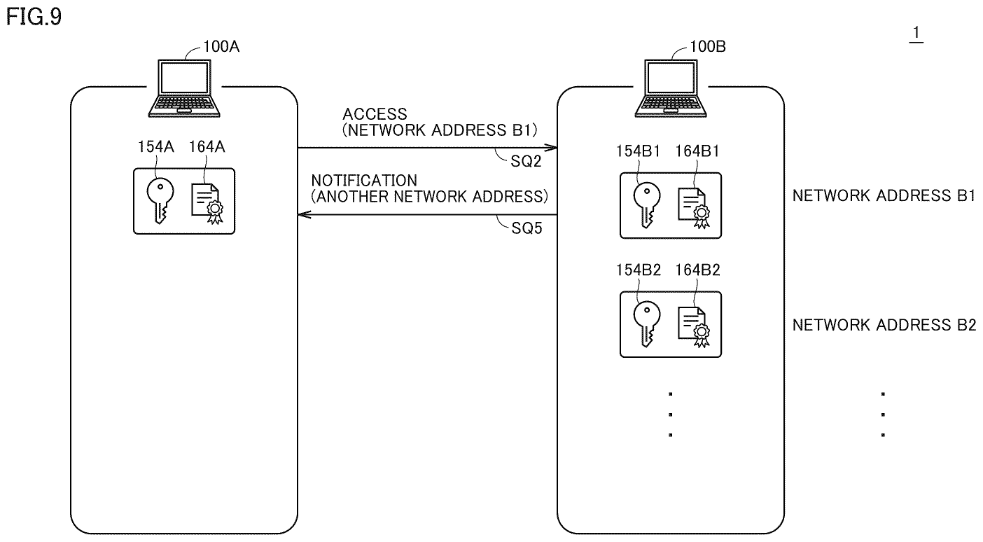

FIG. 9 is a schematic diagram showing an example of processing for notifying of a plurality of network addresses in the network system 1 according to the present embodiment. Referring to FIG. 9, for example, the device 100B may notify the device 100A, which is the source of the access, of the existence of a network address (for example, the network address B2) owned by the device 100B other than the designated network address (network address B1) (sequence SQ5).

Alternatively, the device 100B may notify the device 100A, which is the source of the access, of the existence of a public key (for example, 154B2) corresponding to a network address owned by the device 100B other than the designated network address (network address B1).

Through such communication processing, the device 100 as an access source can see a plurality of network addresses of the device 100 as an access destination.

In addition, the processing for notifying of the existence of the network address or the public key 154 may include not only processing for transmitting a message notifying of the existence of the network address or the public key 154 to the device 100A as an access source but also processing for transmitting the public key 154 to the device 100A as an access source. In addition to the public key 154, the digital certificate 164 associated with the public key 154 may be transmitted to the device 100A as an access source.

Conversely, the device 100 as an access source may be able to inquire of the device 100 as an access destination whether or not the device 100 as an access destination has a plurality of network addresses and/or a plurality of public keys 154.

In addition, when the device 100 having a plurality of network addresses transmits the public key 154 (and the digital certificate 164 associated therewith) to another device 100, the device 100 may transmit a history of network addresses (for example, information for specifying the network address (or the public key 154 corresponding thereto) used immediately before the target network address) together with the public key 154 (and the digital certificate 164 associated therewith). The device 100 as a transmission destination can determine the network address that the device 100 currently has based on the public key 154, and can specify the network addresses that the device 100 had in the past with reference to the history.

In addition, when the routing table 182 includes an entry corresponding to the network address that the device 100 had in the past, the entry corresponding to the network address in the past may be deleted, or the network address in the past may be updated to the current network address determined based on the transmitted public key 154.

In addition, not only the network address that the same device 100 had in the past but also information for specifying the network address used by the same user or organization may be included in the history. For example, when the device 100 used by a certain user is replaced with a new device 100 due to a failure, a history indicating that the network address of the new device 100 has taken over the network address owned by the device 100 that has failed may be transmitted to another device 100. By transmitting such a relationship (history) between network addresses to another device 100, it is possible to update the network address more easily even if the device 100 fails.

In addition, the history of network addresses can also be realized by using a known certificate chain technique. That is, the digital certificate 164 associated with the public key 154 corresponding to a predetermined network address may include information for specifying other network addresses related to the network address (for example, information for specifying the corresponding digital certificate 164).

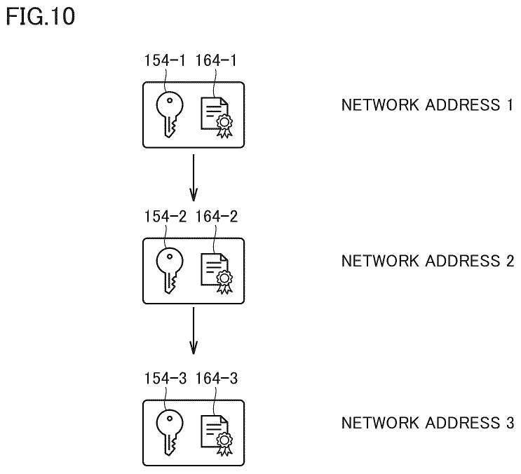

FIG. 10 is a diagram for explaining the history of network addresses in the network system 1 according to the present embodiment. Referring to FIG. 10, for example, it is assumed that the device 100 is currently using a public key 154-3 and a digital certificate 164-3 (corresponding to a network address 3). It is assumed that the device 100 used a public key 154-2 and a digital certificate 164-2 (corresponding to a network address 2) immediately before that and used a public key 154-1 and a digital certificate 164-1 (corresponding to a network address 1) even more before that.

By transmitting the history of network addresses to another device 100, the transition and association of network addresses can be understood. In addition, network addresses other than the currently used network address may be treated as either valid or invalid.

### <E. Validity of Digital Certificate in Network System 1>

In the network system 1 according to the present embodiment, the device 100 can have a plurality of network addresses. One example of a reason why it is necessary to have a plurality of network addresses is the validity of the digital certificate 164 corresponding to the network address. Hereinafter, the digital certificate 164 will be described.

In the network system 1, each device 100 can check the validity of the public key 154 based on the digital certificate 164 associated with the public key 154. When the validity is specified in the digital certificate 164, the validity of the public key 154 cannot be checked if the validity has expired. However, even if the validity of the public key 154 cannot be checked, it is possible to determine the network address (not necessarily an authenticated network address) of the device 100 as a communication partner.

For this reason, when the validity of the digital certificate 164 is about to expire, any predetermined processing is required.

(1) A new digital certificate 164 associated with the same public key 154 is issued.

(2) A new key pair 150 is generated, and the digital certificate 164 associated with the public key 154 included in the new key pair 150 is issued.

When the processing (1) is adopted, a notification that the validity of the digital certificate 164 is about to expire may be given by using a method to be described later.

When the processing (2) is adopted, the network address is changed as the public key 154 of the device 100 is changed.

Therefore, a mechanism is required that allows another device 100 to acquire the changed network address using a predetermined method. As an example, when the validity of the digital certificate 164 is about to expire or has expired, the device 100 may notify the access source (another device 100) of at least one of the existence of the newly issued public key 154 and the existence of a new network address corresponding to the newly issued public key 154. More specifically, the following processing may be adopted.

<F. Processing when Network Address is Changed in Network System 1>

Next, processing for changing a network address in the network system 1 will be described.

### (f1: Processing Example 1)

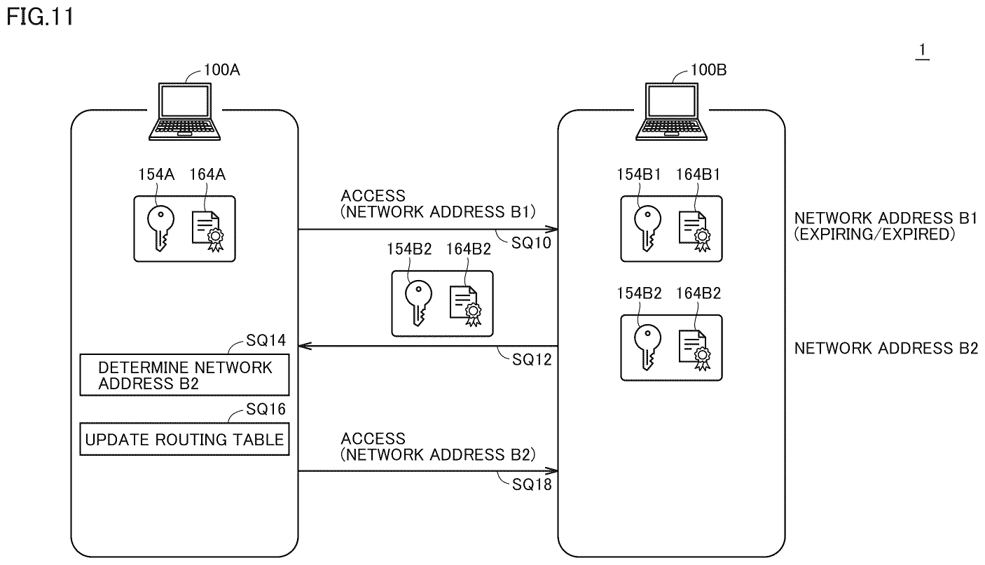

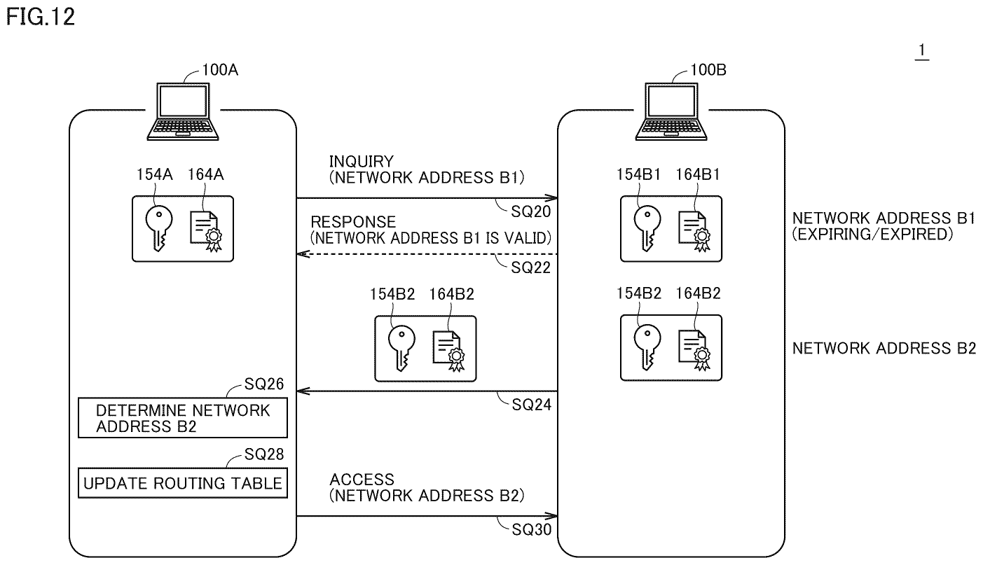

FIG. 11 is a schematic diagram showing an example of processing when a network address is changed in the network system 1 according to the present embodiment. For convenience of explanation, FIG. 11 and FIG. 12 described later illustrate communication processing between the device 100A and the device 100B, but communication processing between other devices 100 is similar.

As an example, it is assumed that the validity of the digital certificate 164B1 associated with the public key 154B1 of the device 100B is about to expire or has expired (the same applies to FIG. 12 described below). Therefore, the device 100B has a new public key 154B2 and a digital certificate 164B2 associated with the public key 154B2 in addition to the public key 154B1 and the digital certificate 164B1. In addition, the public key 154B1 corresponds to a network address B1, and the public key 154B2 corresponds to a network address B2.

It is assumed that the device 100A has acquired the network address B1 of the device 100B in advance and designates the network address B1 to access the device 100B in order to specify the device 100B (sequence SQ10).

Since the validity of the digital certificate 164B1 corresponding to the network address B1 is about to expire or has expired, the device 100B transmits the new public key 154B2 and the digital certificate 164B2 to the device 100A (sequence SQ12).

By detecting in advance that the validity of the digital certificate 164B1 corresponding to the network address B1 is about to expire or has expired, the device 100A may transmit the new public key 154B2 and the digital certificate 164B2 when an access designating the network address B1 is received.

Alternatively, the device 100A may check the validity of the digital certificate 164 corresponding to the network address each time when the device 100A receives an access designating the network address of itself.

The device 100A determines the network address B2 of the device 100B based on the public key 154B2 and the digital certificate 164B2 from the device 100B (sequence SQ14). Then, the device 100A updates the routing table 182 with the network address B2 of the device 100B (sequence SQ16). Thereafter, the device 100A accesses the device 100B by designating the new network address B2 (sequence SQ18).

In this manner, when the public key 154B2 and the digital certificate 164B2 are acquired from the device 100B, the device 100A determines the network address B2 based on the public key 154B2 and updates the routing table 182 with the determined network address B2.

As described above, when the validity of the digital certificate 164B1 associated with the public key 154B1 is about to expire or has expired, upon receiving an access designating the network address B1 determined based on the public key 154B1, the device 100B (validity management module 180) transmits to the access source the public key 154B2 different from the public key 154B1 and the digital certificate 164B2 associated with the public key 154B2. Therefore, even if the validity of the digital certificate 164B1 associated with the public key 154B1 owned by the device 100B is about to expire or has expired, it is possible to seamlessly transition to the new public key 154B2 (network address B2) and the digital certificate 164B2.

That is, even if the network address of the same the device 100 is changed, the communication processing can be continued.

### (f2: Processing Example 2)

FIG. 12 is a schematic diagram showing another example of processing when a network address is changed in the network system 1 according to the present embodiment.

Referring to FIG. 12, the device 100A acquires the network address B1 of the device 100B in advance. Before transmitting data or the like to the device 100B, the device 100A inquires of the device 100B about the validity of the network address B1 (sequence SQ20).

In response to the inquiry from the device 100A, when the validity of the digital certificate 164B1 corresponding to the network address B1 is sufficient, the device 100B responds that the network address B1 is valid (sequence SQ22). In response to the response from the device 100B, the device 100A accesses the device 100B by designating the network address B1.

On the other hand, when the validity of the digital certificate 164B1 corresponding to the network address B1 is about to expire or has expired, the device 100B transmits the new public key 154B2 and the digital certificate 164B2 to the device 100A (sequence SQ24). Alternatively, the device 100B may respond that the network address B1 is not valid.

In this manner, when an inquiry about the validity of the network address B1 is received from another device 100, the device 100B (validity management module 180) responds according to the validity of the digital certificate 164B1. That is, the response content differs depending on whether the validity of the digital certificate 164B1 is about to expire or has expired.

The device 100A determines the network address B2 of the device 100B based on the public key 154B2 and the digital certificate 164B2 from the device 100B (sequence SQ26). Then, the device 100A updates the routing table 182 with the network address B2 of the device 100B (sequence SQ28). Thereafter, the device 100A accesses the device 100B by designating the new network address B2 (sequence SQ30).

In this manner, when the public key 154B2 and the digital certificate 164B2 are acquired from the device 100B, the device 100A determines the network address B2 based on the public key 154B2 and updates the routing table 182 with the determined network address B2.

As described above, when the validity of the digital certificate 164B1 associated with the public key 154B1 is about to expire or has expired, upon receiving an access designating the network address B1 determined based on the public key 154B1, the device 100B (validity management module 180) transmits to the access source the public key 154B2 different from the public key 154B1 and the digital certificate 164B2 associated with the public key 154B2. Therefore, even if the validity of the digital certificate 164B1 associated with the public key 154B1 owned by the device 100B is about to expire or has expired, it is possible to seamlessly transition to the new public key 154B2 (network address B2) and the digital certificate 164B2.

### (f3: Processing Example 3)

The device 100 may be configured to be able to perform both the processing in FIG. 11 and the processing in FIG. 12. For example, the validity of the network address may be inquired of the communication partner only when the time elapsed from the previous access exceeds a predetermined threshold time.

### (f4: Validity Inquiry)

Any certificate authority 200 (registry 250), instead of the device 100 having a network address, may inquire about the validity of the network address shown in FIG. 12.

The timing for inquiring about the validity of the network address can be set arbitrarily. For example, a function for inquiring about the validity of the network address can be prepared, and the application 122 can make an inquiry at a timing required by the application 122.

### (f5: Update of Routing Table 182 and Notification to Application 122)

As described above, when the network address is changed, the contents of the routing table 182 are also updated.

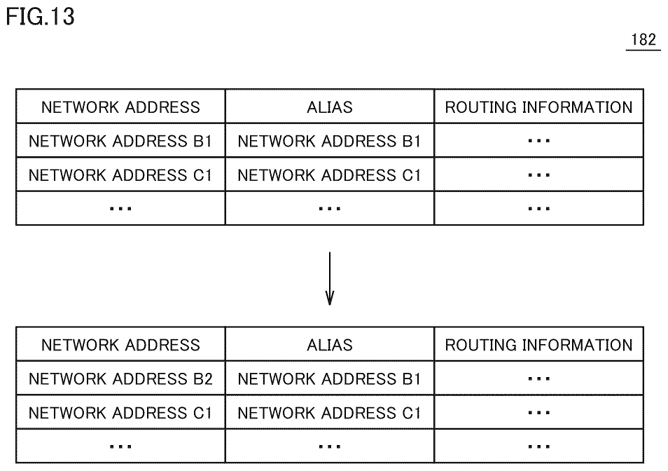

FIG. 13 is a schematic diagram showing an example of updating the routing table 182 in the network system 1 according to the present embodiment. Referring to FIG. 13, the routing table 182 includes routing information for each network address. When a network address is changed, only the corresponding network address may be changed while maintaining the routing information, or an entry including the changed network address and routing information may be added sequentially.

In addition, an alias may be set to maintain the association with the network address before change. By setting the network address before the change to the alias, switching to the changed network address is possible within the device 100 even if any application 122 running on the device 100 performs communication designating the network address before the change.

In addition, the application 122 running on the device 100 may not be able to know that the network address of another device 100 has changed. In such a case, the communication module 170 may notify the application 122 of the network addresses before and after the change.

For example, when the application 122 sends a request for access designating the network address before change to the communication module 170, the communication module 170 may notify the application 122 of the network address after the change corresponding to the designated network address before the change. The application 122 can update the managed network address to the notified network address after the change.

In this manner, the communication module 170 may notify the application 122 running on the device 100 of the changed network address. Through such a notification, changes in the network address of another device 100 can be reflected in the application 122.

(f6: Notification of Public Key/Network Address of Device Other than Host Device)

For example, assuming that a user changes the device 100 that the user is using to another device 100, it is preferable to notify the user of the network address of the new the device 100 in advance. For this reason, the device 100 may notify not only its own network address (public key 154) but also the network address (public key 154) of another device, such as a new device 100.

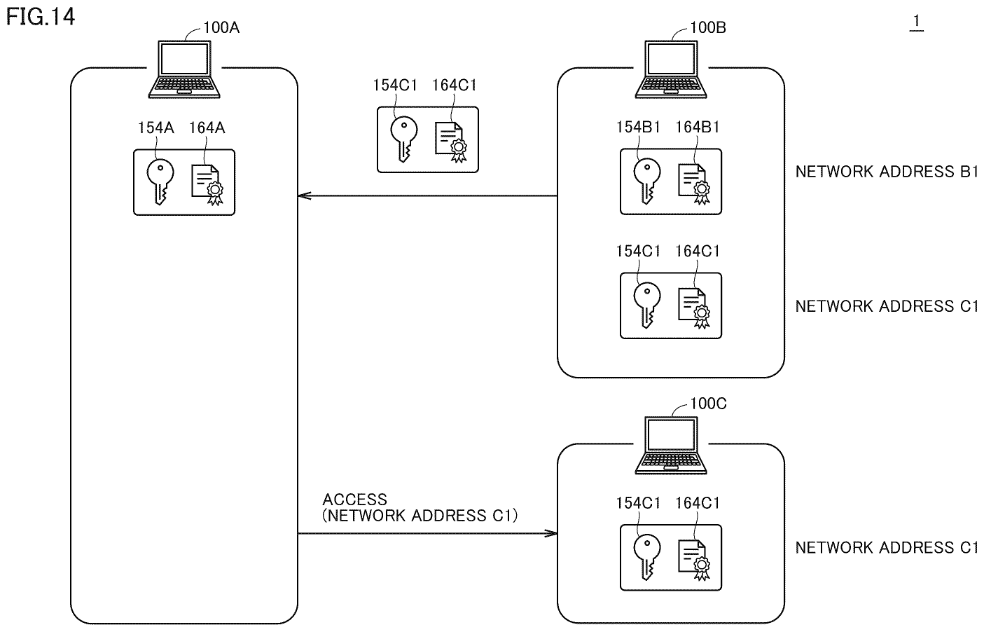

FIG. 14 is a schematic diagram showing an example of processing for notifying of a network address of another device in the network system 1 according to the present embodiment. Referring to FIG. 14, the device 100B has a public key 154C1 of the device 100C and a digital certificate 164C1 associated with the public key 154C1 in addition to its own public key 154B1 and the digital certificate 164B1 associated with the public key 154B1.

In response to an instruction from the user or in response to a given condition being satisfied, the device 100B transmits the public key 154C1 and the digital certificate 164C1 of the device 100C to the device 100A. The device 100A determines a network address C1 based on the public key 154C1 and the digital certificate 164C1. Then, the device 100A designates the network address C1 for access. Since the network address C1 is a network address that the device 100C has, the device 100A accesses the device 100C.

In this manner, the device 100B transmits the public key 154 (and the digital certificate 164 associated therewith) owned by another device to the device 100A, so that the device 100A can perform data communication with another device instead of the device 100B.

By performing communication using such a new network address, it is possible to seamlessly transition to the new device 100 even if the communication destination of the device 100 changes.

### <G. Expiration of Validity>

A network address whose validity of the corresponding digital certificate 164 has expired can be treated as a completely invalid network address, or can be treated as a valid network address although its reliability is low.

When the network address whose validity of the corresponding digital certificate 164 has expired is treated as a completely invalid network address, each device 100 does not transmit data by designating the corresponding network address from itself. When the corresponding network address is designated in data received from another device, each device 100 may discard the corresponding data.

On the other hand, when the network address whose validity of the corresponding digital certificate 164 has expired is treated as a valid network with low reliability, each device 100 may transmit data by designating the corresponding network address from itself. When the corresponding network address is designated in data received from another device, each device 100 may transmit the corresponding data. However, the priority of data transmission may be set relatively low. Setting a low priority may slow down the effective speed of data transmission.

### <H. Notification of Validity>

A mechanism may be adopted that notifies the user of the device 100 or the like when the validity of the digital certificate 164 of the device 100 is about to expire or has expired.

A message may be transmitted from the communication module 170 (validity management module 180) to the application 122 running on the device 100 to notify that the validity is about to expire or has expired. The content or attributes of the message may be changed depending on the remaining time until the expiration date and time of the validity. For example, the content or attributes of the message may be changed stepwise when the remaining period is one month, two weeks, and one week. In addition, the content or attributes of the message may be different according to whether the validity is about to expire or has expired.

When a message notifying that the validity is about to expire or has expired is received from the communication module 170, the application 122 may perform processing according to the received message. The processing to be performed includes, for example, processing for notifying the user of the device 100 or the application 122 that the digital certificate 164 needs to be updated. The processing to be performed can be arbitrarily determined by the creator of the application 122.

Alternatively, an indicator or the like located somewhere on the housing of the device 100 may be used to visually notify that the validity of the digital certificate 164 is about to expire or has expired. Examples of the visual notification method include lighting an indicator, blinking an indicator, and changing the display color of an indicator.

In addition, an audio output device or the like located somewhere on the housing of the device 100 may be used to audibly notify that the validity of the digital certificate 164 is about to expire or has expired. Examples of the auditory notification method include generating the notification sound and changing the notification sound.

A combination of visual notification and auditory notification may be provided. In addition, notification may be given in other forms.

In this manner, the communication module 170 (validity management module 180) of the device 100 notifies the application 122 running on the device 100 that the validity of the digital certificate 164 is about to expire or has expired. Such a notification function allows the user to easily understand that the new digital certificate 164 needs to be acquired.

### <I. Acquisition of New Public Key and Digital Certificate>

Next, an example of processing for acquiring a new public key and digital certificate will be described.

As described above, when the validity of the digital certificate 164 associated with the currently used public key 154 is about to expire or has expired, at least the new digital certificate 164 needs to be acquired. That is, one of the following measures is required: (1) acquire the new digital certificate 164 associated with the same public key 154, or (2) generate the new key pair 150 and acquire the digital certificate 164 associated with the public key 154 included in the key pair 150.

When notifying the user that the validity of the digital certificate 164 associated with the currently used public key 154 is about to expire or has expired, the communication module 170 of the device 100 may also notify the user of the measures (1) and/or (2) described above. In this case, a UI (User Interface) may be provided to notify the user that the validity of the digital certificate 164 associated with the public key 154 currently used by the communication module 170 of the device 100 is about to expire or has expired, and whether to execute (1) or (2) may be accepted.

Alternatively, either (1) or (2) may be set in advance, and the execution of processing for acquiring the new digital certificate 164 using the set method may be accepted when the validity of the digital certificate 164 associated with the currently used public key 154 is about to expire.

In any of the methods described above, the communication module 170 of the device 100 acquires at least the new digital certificate 164 from the certificate authority in response to a user operation.

In addition, in any of the above methods, a UI or the like may be provided to assist in payment of the cost required to acquire the new digital certificate 164. For example, the communication module 170 of the device 100 may provide an input screen for a credit card or the like, and may transmit the input credit card number to a payment server (not shown) to determine the required cost.

In addition, the same process can be performed not only when the validity of the digital certificate 164 has expired, but also when the digital certificate 164 has become invalid for some reason.

### <J. Advantages>

According to the network system 1 according to the present embodiment, seamless communication can be achieved even when one device has a plurality of network addresses.

According to the network system 1 according to the present embodiment, when the device 100 of the communication partner belongs to a different domain, when a plurality of types of hash functions 173 are available, or when the validity of the digital certificate 164 is about to expire or has expired, communication can be continued because the device 100 has a plurality of network addresses and any of the network addresses can be used.

According to the network system 1 according to the present embodiment, in a network that uses a public key and a digital certificate associated with the public key, transition to a new public key and digital certificate can be performed seamlessly to address a problem that the network address cannot be treated as fully authenticated due to the expiration of the validity of the digital certificate. As a result, even if any device needs to acquire a new digital certificate, communication between devices can continue without interruption.

It should be considered that the embodiment disclosed is an example in all points and not restrictive. The scope of the invention is defined by the claims rather than the above description, and is intended to include all modifications within the scope and meaning equivalent to the claims.

### Explanations of Letters or Numerals

1 NETWORK SYSTEM, 100, 100A, 100B, 100C DEVICE, 102 PROCESSOR, 104 MEMORY, 106 STORAGE, 108 DISPLAY, 110 INPUT UNIT, 112 COMMUNICATION UNIT, 120 OS, 122 APPLICATION, 124 COMMUNICATION PROCESSING PROGRAM, 126 INTERFACE, 128 DATA STORAGE AREA, 140 KEY PAIR GENERATION MODULE, 142 EVALUATION MODULE, 150 KEY PAIR, 152, 252 PRIVATE KEY, 154, 154A, 154B1, 154B, 154B2, 154C1 PUBLIC KEY, 160 DIGITAL CERTIFICATE INFORMATION, 162 SIGNATURE, 164, 164A, 164B, 164B2, 164B1, 164C1 DIGITAL CERTIFICATE, 170 COMMUNICATION MODULE, 172 ADDRESS DETERMINATION MODULE, 173 HASH FUNCTION, 174 VALIDITY DETERMINATION MODULE, 176 TABLE MANAGEMENT MODULE, 178 ROUTING MODULE, 180 VALIDITY MANAGEMENT MODULE, 182 ROUTING TABLE, 200 CERTIFICATE AUTHORITY, 240 DIGITAL CERTIFICATE INFORMATION GENERATION MODULE, 242 DIGITAL CERTIFICATE GENERATION MODULE, 250 REGISTRY.

1. A network system, comprising:
a plurality of devices,
wherein each of the plurality of devices includes:
a communication unit for performing data communication with another device; and
a determination unit that determines a network address of the another device based on a public key received from the another device, and
a first device included in the plurality of devices has a first public key and a second public key, and is configured to be able to respond to both an access designating a first network address determined based on the first public key and an access designating a second network address determined based on the second public key.

2. The network system according to claim 1,
wherein the first device is configured to notify at least one of: having a plurality of network addresses and having a plurality of public keys.

3. The network system according to claim 1,
wherein, when the access designating the first network address is received, the first device notifies a source of the access of at least one of existence of the second public key and existence of the second network address.

4. The network system according to claim 3,
wherein the first device has a first digital certificate associated with the first public key, and
when validity of the first digital certificate is about to expire or has expired, the first device notifies the access source of at least one of the existence of the second public key and the existence of the second network address.

5. The network system according to claim 4,
wherein, when an inquiry about validity of the first network address is received from another device, the first device responds according to a validity of the first digital certificate.

6. The network system according to claim 1,
wherein, when the second public key is acquired from the first device, a second device included in the plurality of devices determines a second network address based on the second public key and updates a routing table with the determined second network address.

7. The network system according to claim 6,
wherein the second device notifies an application running on the second device of the second network address.

8. The network system according to claim 6 or 7,
wherein the first device transmits a third public key owned by a third device to the second device.

9. An information processing device capable of performing data communication with another information processing device, comprising:
a determination unit that determines a network address of the another information processing device based on a public key received from the another information processing device,
wherein the information processing device has a first public key and a second public key, and is configured to be able to respond to both an access designating a first network address determined based on the first public key and an access designating a second network address determined based on the second public key.

10. A communication method in a network system including a plurality of devices, comprising:
a step in which each of the plurality of devices stores its own public key;
a step in which each of the plurality of devices determines a network address of another device based on a public key received from the another device; and
a step of responding to both an access designating a first network address determined based on a first public key and an access designating a second network address determined based on a second public key when a first device included in the plurality of devices has the first public key and the second public key.
